(19) United States
(12) Patent Application Publication
(10) Pub. No.: US 2002/0095659 A1
(43) Pub. Date: Jul. 18, 2002

(54) Method and system for providing java interfaces with the functionality of constructors

(76) Inventors: Ronald Michael Jacobs, San Jose, CA (US); Suresh Bathini, San Jose, CA (US)

Correspondence Address: SAWYER LAW GROUP LLP, P.O. Box 51418, Palo Alto, CA, 94303, US

(21) Appl. No.: 09/760,929

(22) Filed: Jan. 16, 2001

(51) Int. Cl. G06F 9/44

(52) U.S. Cl. 717/118; 717/116

(57) ABSTRACT

Method and system aspects for allowing interfaces to have the functionality of constructors in a JAVA coding environment are described. The aspects include specifying a public interface to include an inner class with at least one static function, and encapsulating data to implement the at least one static function. The public interface and at least one static function are then implemented without exposing implementation details.

### FIELD OF THE INVENTION

The present invention relates to the Java programming language, and more particularly to a Java coding technique that allows construction of objects that implement an interface.

### BACKGROUND OF THE INVENTION

Java, Sun Microsystem's trademark for a set of technologies for creating and safely running software programs in both stand-alone and networked environments, is a programming language expressly designed for use in the distributed environment of the Internet. Further, Java was designed to have the “look and feel” of the C++ language, but to be simpler to use than C++ while enforcing an object-oriented programming model.

According to the object-oriented model of Java, created objects are seen as a part of a class of objects and inherit code that is common to the class. In general, a class refers to a prototype that defines the variables and the methods to all objects of a certain kind, and an object refers to a software bundle of variables and related methods. In addition to classes and objects, Java includes the notion of an interface. Unlike classes, which can define methods, an interface simply lists unimplemented, and therefore abstract, methods. Usually, an interface is used to define a protocol of behavior that can be implemented by any class anywhere in the class hierarchy. The object-oriented model also includes a notion of “encapsulation,” a principle whereby implementation details and techniques remain hidden.

The abstract nature of the methods in interfaces is just one way in which an interface differs from a class. Other ways include the ability of an interface to inherit multiple parent interfaces. Unlike classes, interfaces cannot have non-static variables or functions or inner interfaces or inner classes. In addition, interfaces cannot have constructors, where a constructor generally refers to a method that creates an object.

In some coding situations, such as when developing a public API (application program interface), it may become desirable to specify how to construct objects that implement an interface, i.e., to allow an interface to have constructors. Since interfaces normally cannot have constructors, a need exists for a coding technique that allows construction of objects that implement an interface without exposing implementation details and techniques. The present invention addresses such a need.

### SUMMARY OF THE INVENTION

The present invention provides method and system aspects for allowing interfaces to have the functionality of constructors in a JAVA coding environment. The aspects include specifying a public interface to include an inner class with at least one static function, and encapsulating data to implement the at least one static function. The public interface and at least one static function are then implemented without exposing implementation details and techniques.

According to the system and method disclosed herein, traditional coding for interfaces in Java is successfully augmented in a straightforward manner to achieve the ability to construct objects that implement an interface. The augmentation includes the addition of a public inner class that contains one or more static functions. With the use of a private class to support the calls to the static functions, the details of implementation remain encapsulated, thus supporting modularity and information hiding.

### BRIEF DESCRIPTION OF THE DRAWINGS

FIG. 1 illustrates a block diagram of a computer processing system for implementing the present invention.

FIG. 2 illustrates an example of prior art coding for an interface.

FIG. 3 illustrates an example of prior art coding for a class as an implementation of the interface of FIG. 2.

FIG. 4 illustrates a flow diagram for a coding technique that allows construction of objects that implement an interface in accordance with a preferred embodiment of the present invention.

FIGS. 5, 6, and 7 illustrate examples of coding representative of the implementation of the process of FIG. 4.

### DETAILED DESCRIPTION

The present invention relates to a coding technique that allows construction of objects that implement an interface without exposing implementation details and techniques. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

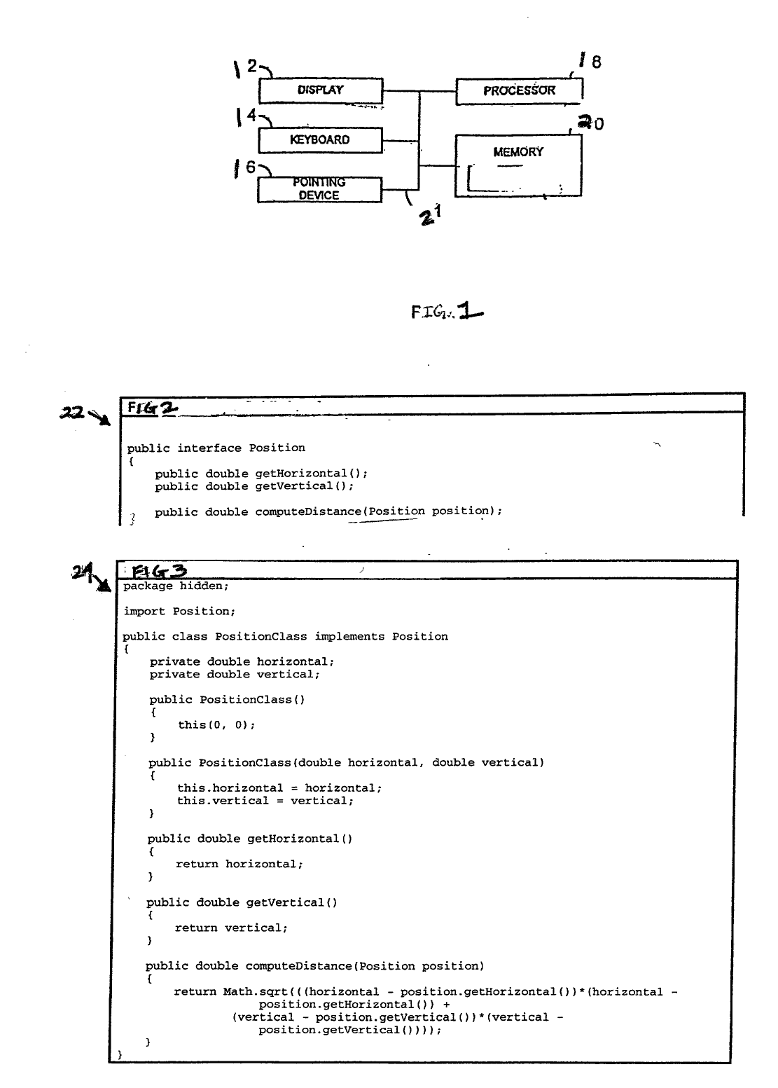

The aspects of the present invention are suitably implemented in a computer processing system, such as represented in the block diagram of FIG. 1. The computer system 10, such as a personal computer (PC) system, includes a display 12, a keyboard 14, a pointing device 16, a processor 18, and memory 20, which are all connected by a bus 21. The processor 18 operates in accordance with an operating system in conjunction with memory 20 to execute operations, such as those described below which provide a coding technique for specifying functions that construct objects that implement an interface in a Java environment. Of course, the functions described herein for controlling the operations of the computer system 10 may be provided via any desired and appropriate computer readable medium, such as a floppy disk, hard disk drive, etc., as is well understood by those skilled in the art.

To help illustrate the aspects of the present invention, the description makes reference to example coding for providing the position of a point and a distance between points. Referring first to FIG. 2, Java coding for a public interface 22 called ‘Position’ is shown that would be suitable according to the prior art. As shown in FIG. 2, the Position interface provides three calls: one for a horizontal value of a position, (‘getHorizontal’); one for a vertical value of a position, (‘getVertical’); and one for computing a distance between two positions, (‘computeDistance’). Every time there is a need for a position, the functionality for the calls of the Position interface 22 would be implemented, such as with PositionClass 24 shown in FIG. 3. Unfortunately there is no way to instantiate a PositionClass object without exposing the details of its implementation. For example, its name (i.e., PositionClass) becomes exposed and the technique for representing its state is exposed, in that the fact that Cartesian coordinates, rather than polar coordinates, are employed becomes known through inspection. Because the PositionClass 24 exposes the implementation details of the calls of the Position interface 22, the ability to encapsulate those details is lost. As is well known in the art, encapsulation provides the benefits of modularity and information hiding, i.e., encapsulation allows source code for an object to be written and maintained independently of the source code for other objects, and allows an object to maintain private information and methods that can be changed at any time without affecting other objects that depend on it.

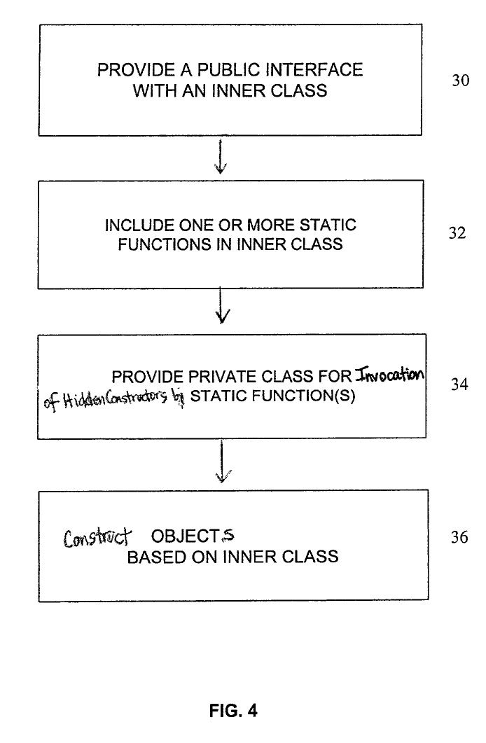

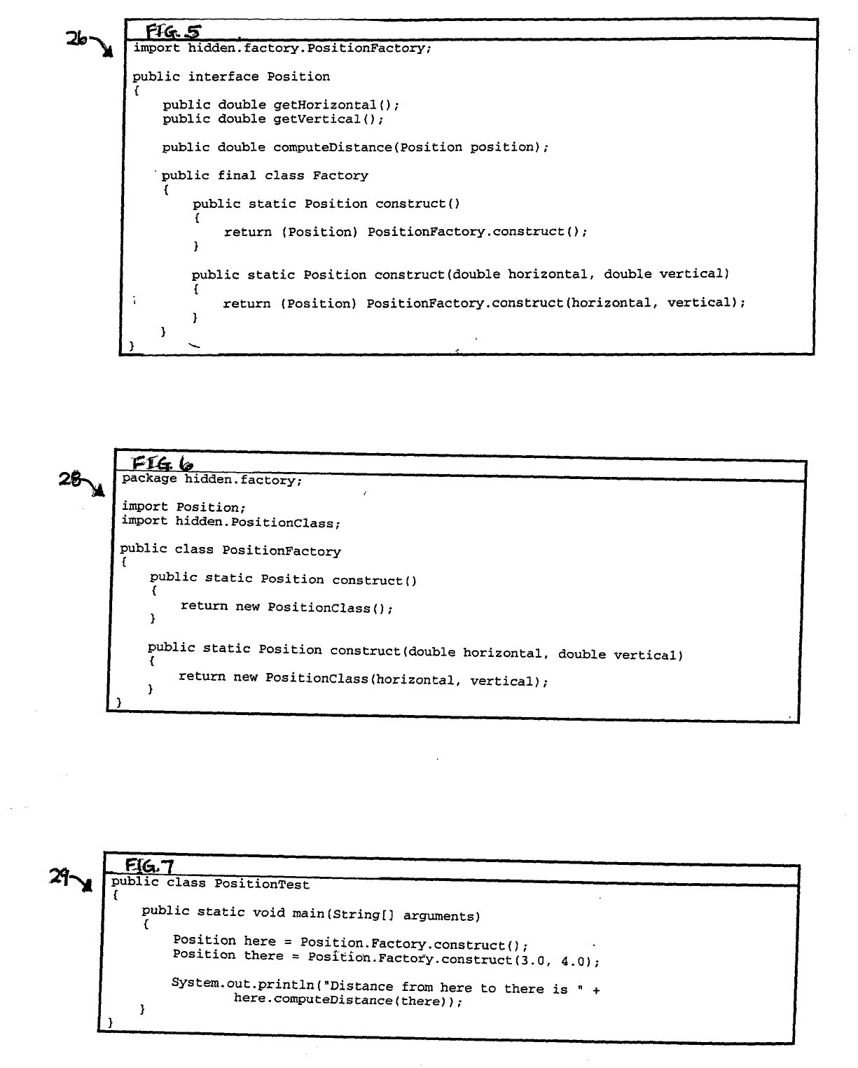

Through the present invention, construction of objects that implement an interface can be achieved while encapsulating the implementation details. A flow chart for the overall coding technique of the present invention is presented in FIG. 4. In the description of FIG. 4, reference is made concurrently to FIGS. 5, 6, and 7, which present coding for the technique for the example of a point's position and distance computation.

Referring to FIG. 4, in a preferred embodiment, standard provision of an interface is augmented including an inner class in an interface (step 30), and including one or more static functions in the inner class (step 32). FIG. 5 illustrates an example of interface 22 (FIG. 2) augmented to produce interface 26, which has an inner class with one or more static functions, i.e., inner class “Factory” with static functions “Position construct ()” and “Position construct (double horizontal, double vertical)”. These two static functions invoke the hidden constructors via a provided private class (step 34). By way of example, FIG. 6 illustrates coding 28 for a private class called ‘PositionFactory’. As shown in FIG. 6, PositionFactory 28 invites the PositionClass constructor 24 of FIG. 3, as a hidden constructor. In this manner, unlike the prior art, the details of the PositionClass 24 do not have to be revealed. Thus, should it be desired to change the position determination to another type of implementation, such as from an x-y Cartesian coordinate basis to a polar basis, the change does not adversely affect any other coding.

Objects that implement the interface can then be constructed (step 36). FIG. 7 illustrates coding for a class 29 called “PositionTest” that demonstrates this technique by using interface 26 of FIG. 5 to construct two Position objects: one at a default position; and another at coordinates (3, 4). Further, the PositionTest 29 specifies that the result of the computation of the distance between positions for the two constructed Position objects be printed to the standard system output device.

As demonstrated by this example, the implementation of an interface by an encapsulated class occurs in a straightforward manner through the aspects of the present invention that successfully augment traditional coding for interfaces in Java. The augmentation includes the addition of a public inner class that contains one or static functions. With the use of a private class to support the calls to the static functions, the details of implementation remain encapsulated, thus providing modularity and information hiding.

The present invention has been described in accordance with the embodiments shown, and one of ordinary skill in the art will readily recognize that there could be variations to the embodiments, and any variations are would be within the spirit and scope of the present invention. In addition, it should be understood that the servers and described herein are controlled by software applications operating in accordance with the present invention that reside within on a computer-readable medium. Accordingly, many modifications may be made by one of ordinary skill in the art without departing from the spirit and scope of the appended claims.

What is claimed is:

1. A method for allowing interfaces to have the functionality of constructors in a JAVA coding environment, the method comprising:
specifying a public interface to include at least one static function;
encapsulating data to implement the at least one static function; and
implementing the public interface and at least one static function, wherein implementation details and techniques are not exposed.

2. The method of claim 1 wherein specifying further comprises specifying the at least one static function in an inner class in the public interface.

3. The method of claim 1 wherein encapsulating data further comprises providing the data as a private class.

4. The method of claim 1 further comprising forming a private class based on the inner class.

5. The method of claim 4 wherein implementing the public interface further comprises utilizing the private class for specifying object constructors.

6. A system for allowing interfaces to have the functionality of constructors in a JAVA coding environment, the system comprising:
a computer processing system; and
computer readable medium containing program instructions executed by the computer processing system, the program instructions comprising JAVA coding for specifying a public interface to include at least one static function, encapsulating data to implement the at least one static function, and implementing the public interface and at least one static function, wherein implementation details and techniques are not exposed.

7. The system of claim 6 wherein specifying further comprises specifying the at least one static function in an inner class in the public interface.

8. The system of claim 6 wherein encapsulating data further comprises providing the data as a private class.

9. The system of claim 6 further comprising forming a private class based on the inner class.

10. The system of claim 9 wherein implementing the public interface further comprises utilizing the private class for specifying object constructors.

11. A method for allowing interfaces to have the functionality of constructors in a JAVA coding environment, the method comprising:
augmenting a public interface to include a public inner class; and
utilizing a private class based on the public inner class to support objects that implement the public interface.

12. The method of claim 11 wherein augmenting a public interface further comprises including at least one static function in the public inner class.

13. The method of claim 11 further comprising encapsulating functionality for the at least one static function.

14. The method of claim 13 further comprising invoking the encapsulated functionality via the private class.
